(19) United States
(12) Patent Application Publication
(10) Pub. No.: US 2014/0347215 A1
(43) Pub. Date: Nov. 27, 2014

(54) MOUNTING DEVICE FOR ANTENNA AND GEODETIC SURVEYING APPARATUS INCLUDING THE SAME

(71) Applicant: Electronics and Telecommunications Research Institute, Daejeon (KR)

(72) Inventors: Seong-Kyun JEONG, Suwon-si Gyeonggi-do (KR); Sang-Uk LEE, Daejeon (KR); Jae-Hoon KIM, Daejeon (KR)

(73) Assignee: Electronics and Telecommunications Research Institute, Daejeon (KR)

(21) Appl. No.: 14/180,018

(22) Filed: Feb. 13, 2014

(30) Foreign Application Priority Data
May 22, 2013 (KR) 10-2013-0057986

(51) Int. Cl. G01S 19/07; H01Q 1/22; G01S 19/01

(52) U.S. Cl. CPC G01S 19/07; G01S 19/01; H01Q 1/22
USPC 342/357.44; 342/357.39; 343/879

(57) ABSTRACT

Disclosed herein is a mounting device for an antenna, including: a first supporting part fixed to any geodetic point in a first direction and having a first length; a second supporting part extended from the first supporting part in a second direction and having a second length; a first mounting part extended from a first point of the second supporting part in the first direction and mounted with a first antenna receiving a first satellite navigation signal transmitted from a navigation satellite; and a second mounting part extended from a second point of the second supporting part in the first direction and mounted with a second antenna receiving a second satellite navigation signal transmitted from the navigation satellite.

### CROSS REFERENCE TO RELATED APPLICATION

This application claims the benefit of Korean Patent Application No. 10-2013-0057986, filed on May 22, 2013, entitled “Mounting Device for Antenna and Geodetic Surveying Apparatus Including the Same”, which is hereby incorporated by reference in its entirety into this application.

### BACKGROUND OF THE INVENTION

1. Technical Field

The present invention relates to a mounting device for an antenna and a geodetic surveying apparatus including the same, and more particularly, to a mounting device for an antenna and a geodetic surveying apparatus including the same capable of precisely surveying a position of a geodetic point by receiving a satellite navigation signal of a navigation satellite.

2. Description of the Related Art

Generally, a geodetic surveying apparatus using a satellite navigation system receives correction information generated through a satellite navigation signal by a satellite navigation reference station, receives navigation information using a satellite navigation receiver installed at a position to be surveyed, and precisely determines the position using both of the correction information and the navigation information. The satellite navigation receiver installed at the position to be surveyed uses a satellite navigation antenna in order to receive the satellite navigation signal. Generally, in order for the satellite navigation antenna to easily receive the satellite navigation signal, a pole having a form of a vertical mounting device is stood and the satellite navigation antenna is installed on the pole. However, in the related art as described above, there is a limitation in performing a geodetic survey on a wall on which the mounting device may not be vertically stood or in the case in which an obstacle is present at an upper end of a position to be surveyed.

At the time of performing the geodetic survey, a specific point should be surveyed at a high precision. However, when a general satellite navigation apparatus is used, a survey can not but be abandoned on the wall or in the case in which the obstacle is present.

Recently, research into a technology for solving a problem of the geodetic surveying apparatus and allowing a position to be precisely surveyed even in a situation in which it is difficult to stand a vertical mounting device due to a geographic feature or at a region in which a satellite navigation signal is not smoothly received due to an obstacle to increase convenience of users using a geodetic surveying receiver has been conducted.

### SUMMARY OF THE INVENTION

An object of the present invention is to provide a mounting device for an antenna and a geodetic surveying apparatus including the same capable of precisely surveying a position of a geodetic point by receiving a satellite navigation signal of a navigation satellite.

According to an exemplary embodiment of the present invention, there is provided a mounting device for an antenna, including: a first supporting part fixed to any geodetic point in a first direction and having a first length; a second supporting part extended from the first supporting part in a second direction and having a second length; a first mounting part extended from a first point of the second supporting part in the first direction and mounted with a first antenna receiving a first satellite navigation signal transmitted from a navigation satellite; and a second mounting part extended from a second point of the second supporting part in the first direction and mounted with a second antenna receiving a second satellite navigation signal transmitted from the navigation satellite.

According to another exemplary embodiment of the present invention, there is provided a geodetic surveying apparatus including: a mounting device for an antenna including a first supporting part fixed to any geodetic point in a first direction, a second supporting part extended from the first supporting part in a second direction, a first mounting part extended from a first point of the second supporting part in the first direction and mounted with a first antenna receiving a first satellite navigation signal transmitted from a navigation satellite, and a second mounting part extended from a second point of the second supporting part in the first direction and mounted with a second antenna receiving a second satellite navigation signal transmitted from the navigation satellite; a correction information receiving module receiving correction information on a satellite navigation signal generated based on a set reference position of any reference geodetic point and a calculated position of the reference geodetic point calculated in the satellite navigation signal received from the navigation satellite; and a control module estimating and calculating a position of any geodetic point based on the first and second satellite navigation signals received from the first and second antennas, respectively, the correction information, and information on the mounting device for an antenna.

### BRIEF DESCRIPTION OF THE DRAWINGS

FIG. 1 is a schematic perspective view illustrating a mounting device for an antenna according to an exemplary embodiment of the present invention;

FIG. 2 is a control block diagram illustrating control components of a geodetic surveying apparatus including the mounting device for an antenna illustrated in FIG. 1; and

FIG. 3 is a flow chart illustrating a method of operating a geodetic surveying apparatus according to the exemplary embodiment of the present invention.

### DESCRIPTION OF THE EXEMPLARY EMBODIMENTS

Hereinafter, exemplary embodiments of the present invention will be described in detail with reference to the accompanying drawings. First, it is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention. In addition, although exemplary embodiments of the present invention will be described below, the scope of the present invention is not limited thereto, but may be variously modified by those skilled in the art.

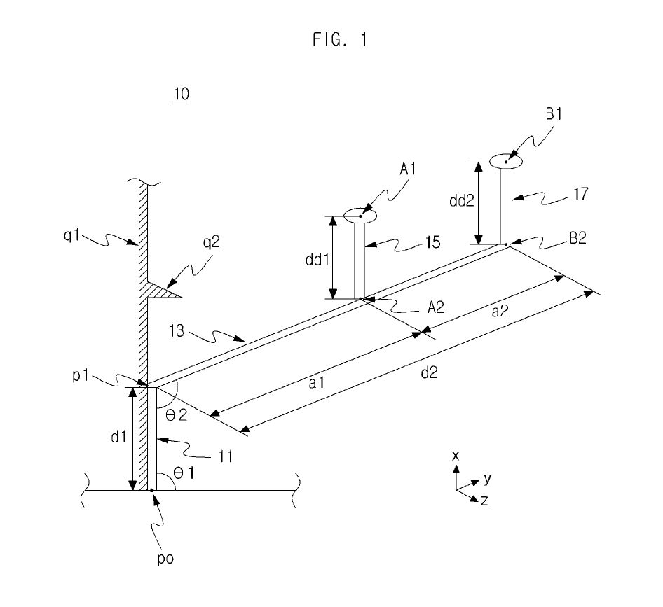

FIG. 1 is a schematic perspective view illustrating a mounting device for an antenna according to an exemplary embodiment of the present invention.

Referring to FIG. 1, the mounting device 10 for an antenna may be configured to include a first supporting part 11, a second supporting part 13, a first mounting part 15, and a second mounting part 17.

Although the case in which the mounting device 10 for an antenna includes two mounting parts 15 and 17 has been described in the exemplary embodiment of the present invention, the number of mounting parts is not limited thereto.

In addition, although the case in which the mounting device 10 for an antenna is disposed on an outer surface of a wall q1 having an obstacle g2 formed thereon is described in the exemplary embodiment of the present invention, the present invention is not limited thereto.

The first supporting part 11 may be disposed to be adjacent to the outer surface of the wall q1 and may be fixed to any geodetic point po deviating from the obstacle q2.

That is, the first supporting part 11 may be extended from the geodetic point po by a first length d1 in a first direction x.

The first direction x indicates a direction perpendicular to the geodetic point po, and an angle θ1 formed by the geodetic point po and the first supporting part 11 may be 90 degrees or an angle adjacent to 90 degrees, for example, 80 to 100 degrees, but is not limited thereto.

In addition, the first supporting part 11 may have a diameter (not illustrated) larger than those of the second supporting part 13 and the first and second mounting parts 15 and 17 in order to support the second supporting part 13 and the first and second mounting parts 15 and 17.

In the exemplary embodiment of the present invention, the first supporting part 11 may have a pipe shape and be attached onto the outer surface of the wall q1, but is not limited thereto.

The second supporting part 13 may be extended from the first supporting part 11 in a second direction y and have a second length d2, and the first and second mounting parts 15 and 17 may be extended from first and second points A2 and B2, respectively.

Here, the first mounting part 15 may be mounted with a first antenna (not illustrated) receiving a first satellite navigation signal from a navigation satellite (not illustrated).

That is, the first mounting part 15 may be extended from the first point A2 in the first direction x, have a first extension length dd1, and have the first antenna mounted at a distal end A1 thereof.

In addition, the second mounting part 17 may be mounted with a second antenna (not illustrated) receiving a second satellite navigation signal from the navigation satellite.

In addition, the second mounting part 17 may be extended from the second point B2 in the first direction x, have a second extension length dd2, and have the second antenna mounted at a distal end B1 thereof.

Here, the second length d2 may be two to six times the first length d1. In the case in which the second length d2 is less than two times the first length d1, it may be difficult to mount the first and second mounting parts 15 and 17 on the second supporting part 13 and mount the first and second antennas on the first and second mounting parts 15 and 17, respectively, and usable ranges may be limited by a size of the obstacle q2. Meanwhile, in the case in which the second length d2 is more than six times the first length d1, it may be difficult to balance the second supporting part 13 due to weights of the first and second antennas mounted on the second supporting part 13 and it may be difficult to fix the first supporting part 11 to the wall q1.

In addition, an angle θ2 between the first and second supporting parts 11 and 13 may be 100 to 130 degrees. In the case in which the angle θ2 between the first and second supporting parts 11 and 13 is less than 100 degrees, a connection point p1 between the first and second supporting parts 11 and 13 may be damaged by the second supporting part 13. Meanwhile, in the case in which the angle θ2 between the first and second supporting parts 11 and 13 is more than 130 degrees, the connection point p1 between the first and second supporting parts 11 and 13 may be damaged by weights of the first and second mounting parts 15 and 17 extended from the second supporting part 13 and the first and second antennas.

The second extension length dd2 may be one to two times the first extension length dd1. In the case in which the second extension length dd2 is less than one time the first extension length dd1 or is more than two times the first extension length dd1, it may be difficult for the second supporting part 13 to support the weights of the first and second antennas. In addition, at least one of the first and second extension lengths dd1 and dd2 may be one to two times the first length d1.

In addition, a first distance al from the connection point p1 between the first and second supporting parts 11 and 13 to the first point A2 may be half to one time a second distance a2 from the first point A2 to the second point B2, but is not limited thereto.

In the exemplary embodiment of the present invention, the satellite navigation signal and the first and second satellite navigation signals are transmitted from the navigation satellite at the same point in time and are differently represented for explanation.

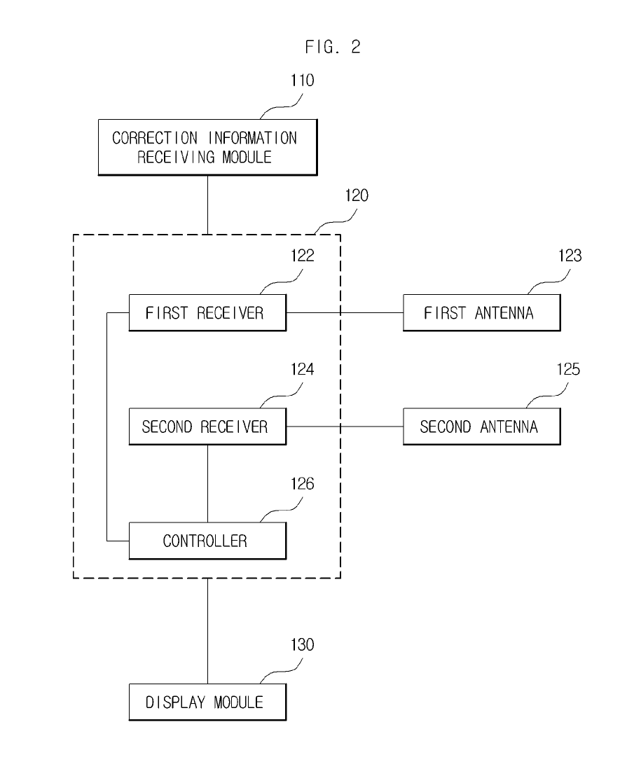

FIG. 2 is a control block diagram illustrating control components of a geodetic surveying apparatus including the mounting device for an antenna illustrated in FIG. 1.

Referring to FIG. 2, the geodetic surveying apparatus 100 may be configured to include the mounting device 10 for an antenna, a correction information receiving module 110, a control module 120, and a display module 130. Here, since the mounting device 10 for an antenna has been illustrated in FIG. 1 and has been described above, a detailed description thereof will be omitted.

The correction information receiving module 110 may receive correction information on a satellite navigation signal generated based on a set reference position of any reference geodetic point and a calculated position of the reference geodetic point calculated in the satellite navigation signal received from a navigation satellite (not illustrated).

That is, the correction information receiving module 110 may be a satellite navigation receiver receiving the satellite navigation signal from a satellite navigation reference station, that is, a geodetic surveying apparatus of a user and the reference geodetic point and generating the correction information.

The correction information may include survey error information between the reference position and the calculated position, but is not limited thereto.

The control module 120 may include a first receiver 122, a second receiver 124, and a controller 126.

The first receiver 122 may receive a first satellite navigation signal transmitted from the navigation satellite from a first antenna 123 disposed at the distal end A1 of the first mounting part 15 of the mounting device 10 for an antenna.

In this case, the first receiver 122 may calculate a position of the first antenna 123, that is, a position of the distal end A1 of the first mounting part 15, based on the first satellite navigation signal and the correction signal.

The second receiver 124 may receive a second satellite navigation signal transmitted from the navigation satellite from a second antenna 125 disposed at the distal end B1 of the second mounting part 17 of the mounting device 10 for an antenna and calculate a position of the second antenna 125, that is, a position of the distal end B1 of the second mounting part 17, based on the second satellite navigation signal and the correction signal.

The controller 126 may estimate and calculate a position of the geodetic point po based on the positions of the first and second antennas 15 and 17 and information on the mounting device 10 for an antenna.

Here, the information on the mounting device 10 for an antenna may include at least one of the first length d1 of the first supporting part 11, the second length d2 of the second supporting part 13, the first extension length dd1 of the first mounting part 15, the second extension length dd2 of the second mounting part 17, and a ratio between distances from the connection point p1 between the first and second supporting parts 11 and 13 to the first and second points A2 and B2, that is, information on positions of the first and second points A2 and B2 for the second length d2, as illustrated in FIG. 1.

That is, the controller 126 may calculate the position of the first point A2 by subtracting the first extension length dd1, that is, an altitude, from the position of the first antenna 123 calculated by the first receiver 122 in a direction opposite to the first direction x, calculate a position of the connection point p1 between the first and second supporting parts 11 and 13 by applying at least one of the position of the first point A2, the ratio between the distances from the connection point p1 between the first and second supporting parts 11 and 13 to the first and second point A2 and B2, and the angle θ2, and estimate and calculate a first calculated position of the geodetic point po by subtracting the first length d1, that is, an altitude, from the position of the connection point p1 between the first and second supporting parts 11 and 13 in the direction opposite to the first direction x.

Then, the controller 126 may calculate the position of the second point B2 by subtracting the second extension length dd2, that is, an altitude, from the position of the second antenna 125 calculated by the second receiver 124 in a direction opposite to the first direction x, calculate a position of the connection point p1 between the first and second supporting parts 11 and 13 by applying at least one of the position of the second point B2, the ratio between the distances from the connection point p1 between the first and second supporting parts 11 and 13 to the first and second point A2 and B2, and the angle θ2, and estimate and calculate a second calculated position of the geodetic point po by subtracting the first length d1, that is, an altitude, from the position of the connection point p1 between the first and second supporting parts 11 and 13 in the direction opposite to the first direction x.

The controller 126 may precisely estimate and calculate a position of the geodetic point po based on the first and second calculated positions.

Here, the controller 126 may control the display module 130 to display the position of the geodetic point po.

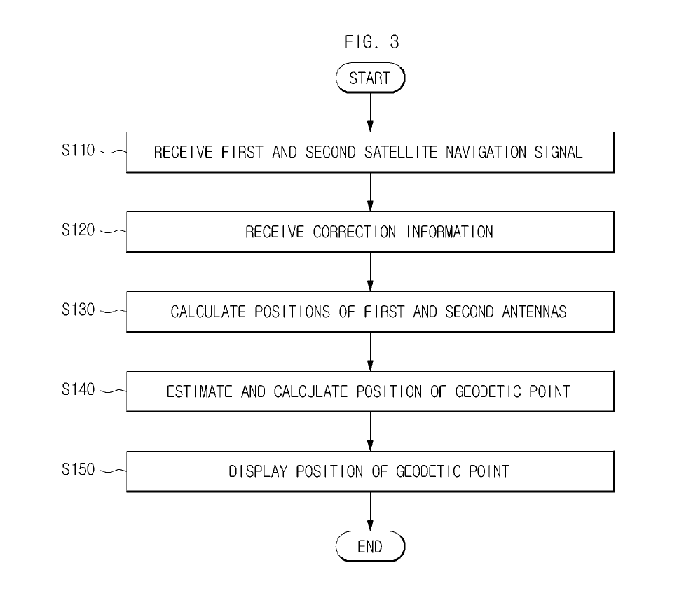

FIG. 3 is a flow chart illustrating a method of operating a geodetic surveying apparatus according to the exemplary embodiment of the present invention.

Referring to FIG. 3, the geodetic surveying apparatus 100 receives a first satellite navigation signal transmitted from a navigation satellite from a first antenna 123 mounted at a first mounting part 15 of a mounting device 10 for an antenna and receives a second satellite navigation signal transmitted from the navigation satellite from a second antenna 125 mounted at a second mounting part 17 of the mounting device 10 for an antenna (S110), and receives correction information on a satellite navigation signal generated based on a set reference position of any reference geodetic point and a calculated position of the reference geodetic point calculated in the satellite navigation signal received from the navigation satellite (S120).

Then, the geodetic surveying apparatus 100 calculates a position of the first antenna 123, that is, a position of a distal end A1 of the first mounting part 15, based on the first satellite navigation signal and the correction signal and calculates a position of the second antenna 125, that is, a position of a distal end B1 of the second mounting part 17, based on the second satellite navigation signal and the correction signal (S130).

The geodetic surveying apparatus 100 may estimate and calculate positions of first and second points A2 and B2 of the second supporting part 13, a position of a connection point p1 between the first and second supporting parts 11 and 13, and a position of a geodetic point po based on the positions of the first and second antennas 123 and 125 and information on the mounting device 10 for an antenna (S140). Since this process has been described above, a detailed description thereof will be omitted.

The geodetic surveying apparatus 100 may display the estimated and calculated position of the geodetic point po (S150).

The mounting device for an antenna and the geodetic surveying apparatus including the same according the exemplary embodiment of the present invention may easily survey a geodetic point of a space in which an obstacle is present or a space in which it is difficult to install a vertical mounting device for an antenna and may precisely survey a position of the geodetic point by using at least two antennas.

The mounting device for an antenna and the geodetic surveying apparatus including the same according to the exemplary embodiment of the present invention may perform a survey at a region and a place at which a geodetic survey may not be precisely performed by using satellite navigation and increase a range in which a survey may be performed, such that a survey may be performed at various regions using only a satellite navigation apparatus. Therefore, utilization of the mounting device for an antenna and the geodetic surveying apparatus including the same according to the exemplary embodiment of the present invention may be increased. In addition, an additional apparatus is used at a region in which a survey may not be performed, thereby making it possible to decrease a cost required for performing a geodetic survey.

Although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent hardware, some or all of the respective components which are selectively combined with each other may be implemented by a computer program having a program module performing some or all of functions combined with each other in one or plural hardware. In addition, the computer program as described above may be stored in computer readable media such as a universal serial bus (USB) memory, a compact disk (CD), a flash memory, or the like, and be read and executed by a computer to implement the exemplary embodiment of the present invention. An example of the computer readable media may include magnetic recording media, optical recording media, carrier wave media, and the like.

In addition, unless defined otherwise in the detailed description, all the terms including technical and scientific terms have the same meaning as meanings generally understood by those skilled in the art to which the present invention pertains. Generally used terms such as terms defined in a dictionary should be interpreted as the same meanings as meanings within a context of the related art and should not be interpreted as ideally or excessively formal meanings unless clearly defined in the present specification.

The spirit of the present invention has been described by way of example hereinabove, and the present invention may be variously modified, altered, and substituted by those skilled in the art to which the present invention pertains without departing from essential features of the present invention. Accordingly, the exemplary embodiments disclosed in the present invention and the accompanying drawings do not limit but describe the spirit of the present invention, and the scope of the present invention is not limited by the exemplary embodiments. The scope of the present invention should be interpreted by the following claims and it should be interpreted that all spirits equivalent to the following claims fall with the scope of the present invention.

What is claimed is:

1. A mounting device for an antenna, comprising:
a first supporting part fixed to any geodetic point in a first direction and having a first length;
a second supporting part extended from the first supporting part in a second direction and having a second length;
a first mounting part extended from a first point of the second supporting part in the first direction and mounted with a first antenna receiving a first satellite navigation signal transmitted from a navigation satellite; and
a second mounting part extended from a second point of the second supporting part in the first direction and mounted with a second antenna receiving a second satellite navigation signal transmitted from the navigation satellite.

2. The mounting device for an antenna of claim 1, wherein the second length is two to six times the first length.

3. The mounting device for an antenna of claim 1, wherein the first direction indicates a direction perpendicular to a surface of the geodetic point.

4. The mounting device for an antenna of claim 1, wherein the second direction is a direction in which an angle between the first and second supporting parts is 100 to 130 degrees.

5. The mounting device for an antenna of claim 1, wherein the first mounting part is extended from the first point by a first extension length, and
the second mounting part is extended from the second point by a second extension length that is half to three times the first extension length.

6. The mounting device for an antenna of claim 5, wherein at least one of the first and second extension lengths is one to two times the first length.

7. The mounting device for an antenna of claim 1, wherein a first distance from a connection point between the first and second supporting parts to the first point is half to one time a second distance from the first point to the second point.

8. A geodetic surveying apparatus comprising:
a mounting device for an antenna including a first supporting part fixed to any geodetic point in a first direction, a second supporting part extended from the first supporting part in a second direction, a first mounting part extended from a first point of the second supporting part in the first direction and mounted with a first antenna receiving a first satellite navigation signal transmitted from a navigation satellite, and a second mounting part extended from a second point of the second supporting part in the first direction and mounted with a second antenna receiving a second satellite navigation signal transmitted from the navigation satellite;
a correction information receiving module receiving correction information on a satellite navigation signal generated based on a set reference position of any reference geodetic point and a calculated position of the reference geodetic point calculated in the satellite navigation signal received from the navigation satellite; and
a control module estimating and calculating a position of any geodetic point based on the first and second satellite navigation signals received from the first and second antennas, respectively, the correction information, and information on the mounting device for an antenna.

9. The geodetic surveying apparatus of claim 8, wherein the correction information includes survey error information between the reference position and the calculated position.

10. The geodetic surveying apparatus of claim 8, wherein the information on the mounting device for an antenna includes at least one of a first length by which the first supporting part is extended, a second length by which the second supporting part is extended, a first extension length of the first mounting part, a second extension length of the second mounting part, and a ratio between distances from a connection point between the first and second supporting parts to the first and second points.

11. The geodetic surveying apparatus of claim 8, wherein the control module includes:
a first receiver calculating a position of the first antenna based on the first satellite navigation signal and the correction information;
a second receiver calculating a position of the second antenna based on the second satellite navigation signal and the correction information; and
a controller estimating and calculating the position of any geodetic point based on the positions of the first and second antennas and the information on the mounting device for an antenna.

12. The geodetic surveying apparatus of claim 11, wherein the first receiver calculates the position of the first antenna by correcting a calculated position of the first antenna calculated from the first satellite navigation signal with survey error information included in the correction information, and
the second receiver calculates the position of the second antenna by correcting a calculated position of the second antenna calculated from the second satellite navigation signal with the survey error information.

13. The geodetic surveying apparatus of claim 8, wherein the information on the mounting device for an antenna includes at least one of a first length by which the first supporting part is extended, a second length by which the second supporting part is extended, a first extension length of the first mounting part, a second extension length of the second mounting part, and a ratio between distances from a connection point between the first and second supporting parts to the first and second points, and
the controller calculates a position of the first point by subtracting the first extension length from a position of the first antenna, calculates a position of the connection point between the first and second supporting parts by applying the position of the first point and the ratio between the distances from the connection point between the first and second supporting parts to the first and second points, calculates a first calculated position of any geodetic point by subtracting the first length from the position of the connection point between the first and second supporting parts, calculates a position of the second point by subtracting the second extension length from a position of the second antenna, calculates a position of the connection point between the first and second supporting parts by applying the position of the second point and the ratio between the distances from the connection point between the first and second supporting parts to the first and second points, calculates a second calculated position of any geodetic point by subtracting the first length from the position of the connection point between the first and second supporting parts, and estimates and calculates the position of the geodetic point depending on the first and second calculated positions.

14. The geodetic surveying apparatus of claim 8, further comprising a display module displaying the position of the geodetic point.

15. The geodetic surveying apparatus of claim 8, wherein the satellite navigation signal and the first and second satellite navigation signals are transmitted from the navigation satellite at the same point in time.
